(19) United States
(12) Patent Application Publication
(10) Pub. No.: US 2022/0213125 A1
(43) Pub. Date: Jul. 7, 2022

(54) Extruded Metal-organic Framework Materials and Methods For Production Thereof

(71) Applicant: ExxonMobil Research and Engineering Company, Annandale, NJ (US)

(72) Inventors: Gerardo J. Majano, Basking Ridge, NJ (US); Joseph M. Falkowski, Hampton, NJ (US); Scott J. Weigel, Allentown, PA (US); Matthew T. Kapelewski, Bethlehem, PA (US); Pavel Kortunov, Flemington, NJ (US)

(21) Appl. No.: 17/612,464

(22) PCT Filed: Dec. 13, 2019
(86) PCT No.: PCT/US2019/066176

§ 371 Date: Nov. 18, 2021

Related U.S. Application Data
(60) Provisional application No. 62/797,999, filed on Jan. 29, 2019.

(51) Int. Cl. C07F 1/08; B22F 1/10; B22F 3/20; C01B 37/00

(52) U.S. Cl. CPC C07F 1/08; B22F 1/10; B22F 3/20; B22F 2302/45; C01P 2002/72; C01P 2006/12; C01B 37/00

(57) ABSTRACT

Metal-organic frameworks (MOFs) are highly porous entities comprising a multidentate ligand coordinated to multiple metal atoms, typically as a coordination polymer. MOFs are usually produced in powder form. Extrusion of powder-form MOFs to produce shaped bodies has heretofore proven difficult due to loss of surface area and poor crush strength of MOF extrudates, in addition to phase transformations occurring during extrusion. The choice of mixing conditions and the mixing solvent when forming MOF extrudates can impact these factors. Extrudates comprising a MOF consolidated material may feature the MOF consolidated material having a BET surface area of about 50% or greater relative to that of a pre-crystallized MOF powder material used to form the extrudate. X-ray powder diffraction of the extrudate shows about 20% or less conversion of the MOF consolidated material into a phase differing from that of the pre-crystallized MOF powder material.

### FIELD

The present disclosure relates to extrusion or compaction of metal-organic framework materials.

### BACKGROUND

Metal-organic frameworks (MOFs) are a relatively new class of highly porous materials with potential applications in a wide range of fields including gas storage, gas and liquid separations, isomer separation, waste removal, and catalysis, among others. In contrast to zeolites, which are purely inorganic in character, MOFs comprise multidentate organic ligands that function as “struts” bridging metal atoms or clusters of metal atoms together in an extended coordination structure (e.g., as a coordination polymer). Like zeolites, MOFs are microporous and exhibit a range of structures, including tunability of the pore shape and size through selection of the multidentate organic ligands and the metal. Because organic ligands may be readily modified, MOFs as a whole exhibit a much greater breadth of structural diversity than is found for zeolites. Indeed, tens of thousands of MOF structures are now known, compared to only a few hundred unique zeolite structures. Factors that may influence the structure of MOFs include, for example, one or more of ligand denticity, size and type of the coordinating group(s), additional substitution remote or proximate to the coordinating group(s), ligand size and geometry, ligand hydrophobicity or hydrophilicity, choice of metal(s) and/or metal salt(s), choice of solvent(s), and reaction conditions such as temperature, concentration, and the like.

MOFs are typically synthesized or obtained commercially as loose, unconsolidated microcrystalline powder materials. For many industrial and commercial products, shaping powder-form MOFs into larger, more coherent bodies having a defined shape would be desirable. Unfortunately, conventional routes for consolidating powder-form MOFs into coherent bodies, such as pelletizing and extrusion, have oftentimes afforded less than desirable physical and mechanical properties. Specifically, processing of powder-form MOFs into coherent bodies through compaction may result in BET surface areas that are considerably lower than those of the powder-form MOF due to pressure sensitivity of the MOF structure. Crush strength values also may be relatively low for consolidated MOFs. Finally, the conditions used for forming consolidated MOFs have sometimes led to full or partial phase transformation of the initial MOF structure, as evidenced by x-ray powder diffraction and BET surface area analyses. All of these factors may be problematic for producing shaped bodies comprising MOFs and/or using the shaped bodies in various applications. For example, fines production from shaped bodies having low crush strength values may limit applicability of MOFs in catalysis and other processes that might otherwise be advantageous and feasible. Unwanted pressure drops and mass transfer limitations may occur as a result of fines production, which may present engineering challenges in various cases.

### SUMMARY

In certain aspects, the present disclosure provides extrudates formed from a metal-organic framework consolidated material that maintain or improve upon one or more desirable properties of a pre-crystallized metal-organic framework powder material. Specifically, the extrudates comprise a metal-organic framework consolidated material formed via extrusion of a mull comprising a pre-crystallized metal-organic framework powder material. The metal-organic framework consolidated material has a BET surface area of about 50% or greater relative to that of the pre-crystallized metal-organic framework powder material, and x-ray powder diffraction of the extrudate shows about 20% or less conversion of the pre-crystallized metal-organic framework powder material into a different phase within the metal-organic framework consolidated material following extrusion, as measured by peak intensity of one or more x-ray powder diffraction peaks.

In other aspects, the present disclosure provides methods for extruding metal-organic framework consolidated materials that maintain or improve upon one or more desirable properties of a pre-crystallized metal-organic framework powder material. The methods comprise: combining a pre-crystallized metal-organic framework powder material with a solvent, the solvent comprising one or more solvents used to form the pre-crystallized metal-organic framework powder material; mixing the pre-crystallized metal-organic framework powder material with the solvent to form a mulled metal-organic framework paste; and extruding the mulled metal-organic framework paste to form an extrudate comprising a metal-organic framework consolidated material. Mixing is conducted such that about 20% or less of the pre-crystallized metal-organic framework powder material is transformed into a different phase, as determined by x-ray powder diffraction. The metal-organic framework consolidated material has a BET surface area of about 50% or greater relative to that of the pre-crystallized metal-organic framework powder material, and x-ray powder diffraction of the extrudate shows about 20% or less conversion of the pre-crystallized metal-organic framework powder material into a different phase within the metal-organic framework consolidated material following extrusion, as measured by peak intensity of one or more x-ray powder diffraction peaks.

In still other aspects, the present disclosure provides methods for extruding metal-organic framework consolidated materials using an alcoholic solvent during mixing and extrusion. The methods comprise: combining a pre-crystallized metal-organic framework powder material with a solvent selected from the group consisting of an alcohol and an alcohol/water mixture; mixing the pre-crystallized metal-organic framework powder material with the solvent to form a mulled metal-organic framework paste; and extruding the mulled metal-organic framework paste to form an extrudate comprising a metal-organic framework consolidated material. Mixing is conducted such that about 20% or less of the pre-crystallized metal-organic framework powder material is transformed into a different phase, as determined by x-ray powder diffraction. The metal-organic framework consolidated material has a BET surface area of about 50% or greater relative to that of the pre-crystallized metal-organic framework powder material, and x-ray powder diffraction of the extrudate shows about 20% or less conversion of the pre-crystallized metal-organic framework powder material into a different phase within the metal-organic framework consolidated material following extrusion, as measured by peak intensity of one or more x-ray powder diffraction peaks.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, as will occur to one of ordinary skill in the art and having the benefit of this disclosure.

FIGS. 1A and 1B show x-ray powder diffraction data for native HKUST-1 and HKUST-1 samples pelletized at various hydraulic pressures.

FIG. 2 shows x-ray powder diffraction data for HKUST-1 powder material before and after mulling in the presence of water.

FIG. 3 shows x-ray powder diffraction data for HKUST-1 powder material before and after mulling with various binder additives in the presence of water.

FIG. 4 shows x-ray powder diffraction data for HKUST-1 powder material before and after mulling with DMF or water:DMF and after extrusion.

FIG. 5 shows x-ray powder diffraction data for HKUST-1 powder material before and after mulling with water:ethanol and after extrusion.

FIG. 6A shows comparative x-ray powder diffraction and BET surface area data for HKUST-1 extrudates formed from mulls containing various ratios of water:ethanol.

FIG. 6B shows comparative N₂ adsorption isotherms for HKUST-1 extrudates formed from mulls containing various ratios of water:ethanol.

FIG. 7A shows comparative x-ray powder diffraction and BET surface area data for HKUST-1 extrudates formed from mulls containing various binder additives. FIG. 7B shows the corresponding N₂ adsorption isotherms.

FIG. 8A shows comparative x-ray powder diffraction data for HKUST-1 extrudates formed from mulls containing various alcohols. FIG. 8B shows the corresponding N₂ adsorption isotherms.

FIG. 9 shows a plot of methane uptake for HKUST-1 powder in comparison to several HKUST-1 extrudates.

FIGS. 10A-10D show illustrative breakthrough plots for ethane/ethylene gas absorption for HKUST-1 powder (FIGS. 10A and 10B) and HKUST-1 extrudate (FIGS. 10C and 10D).

FIGS. 11A and 11B show the performance of various HKUST-1 extrudates for uptake of p-xylene and o-xylene, respectively, in comparison to that of HKUST-1 powder and HKUST-1 pressed pellets.

FIG. 12 shows comparative x-ray powder diffraction data for as-synthesized ZIF-7 and heat-desolvated ZIF-7.

FIG. 13 shows comparative x-ray powder diffraction data for pellets formed from dried and as-synthesized ZIF-7 and as-synthesized ZIF-7 powder.

FIG. 14 shows comparative CO2 adsorption isotherms at 28° C. for ZIF-7 extrudates in comparison to activated ZIF-7 powder.

FIG. 15A shows comparative x-ray powder diffraction data for ZIF-8 powder and a ZIF-8 extrudate. FIG. 15B shows corresponding N₂ adsorption isotherms at 77 K.

FIG. 16A shows methane adsorption isotherms for ZIF-8 extrudate in comparison to ZIF-8 powder. FIG. 16B shows ethylene adsorption isotherms for ZIF-8 extrudate in comparison ZIF-8 powder.

FIG. 17 shows a plot of o/p-xylene uptake by a ZIF-8 extrudate in comparison to that of ZIF-8 powder.

FIG. 18A shows comparative x-ray powder diffraction data for UiO-66 powder and a UiO-66 pellet. FIG. 18B shows corresponding N₂ adsorption isotherms at 77 K.

FIG. 19A shows comparative x-ray powder diffraction patterns for UiO-66 extrudates containing VERSAL 300. FIG. 19B shows corresponding N₂ adsorption isotherms at 77 K.

### DETAILED DESCRIPTION

The present disclosure generally relates to metal-organic frameworks and, more specifically, to consolidation of metal-organic frameworks into a shaped body having a defined shape.

As discussed in brief above, it can be desirable to consolidate a metal-organic framework (MOF) powder material into a more coherent (shaped) body comprising a metal-organic framework consolidated material. However, the properties of metal-organic framework materials, specifically their weakness against pressure and shear, may lead to various issues when consolidating a MOF powder material to form a shaped body. One issue is that the intense pressures (e.g., about 100 psi to several thousand psi) and shear used to consolidate powder-form MOFs, particularly during extrusion, may collapse at least a portion of the pores within the MOF structure and lead to an undesirable and oftentimes significant decrease in BET surface area. Another issue is that the conditions used for consolidating powder-form MOFs into a shaped body may lead to at least partial and sometimes full conversion of the MOF structure into another material, such as another crystalline phase. Consolidated MOFs exhibiting poor crush strength may also be problematic in some cases. For example, poor crush strength values may lead to production of lines, which may be detrimental to certain applications.

The present disclosure provides the surprising discovery that a powder-form MOF material may be extruded to form a shaped body that at least maintains one or more of the foregoing properties at desirable levels. Specifically, the present disclosure demonstrates that several extrusion process parameters may be selected in combination with one another to afford extrudates comprising a MOF consolidated material that provides advantages over previous MOF extrudates and MOF powder materials that are otherwise unconsolidated. Extrusion parameters that may be selected to afford extrudates according to the present disclosure include, for example, forming a mull of a MOF powder material and a solvent under mild mixing conditions, and choosing a solvent that promotes retention of BET surface area and the crystalline phase of the MOF powder material during and following consolidation into a shaped body. Related pelletization processes for compacting metal-organic framework power materials through application of hydraulic pressure may similarly benefit by applying the concepts outlined herein.

The solvent used for forming a mull during extrusion may be selected from a solvent in which the MOF is stable and the solvent is compatible with the extrusion conditions. In some cases, the solvent used for forming a mull may be chosen from among a solvent suitable for synthesizing and/or crystallizing the powder-form MOF itself. That is, without being bound by any theory or mechanism, solvents that stabilize the MOF structure during synthesis may similarly aid in stabilizing the MOF while applying pressure and shear during formation of a shaped body. In some instances, the solvent selection may limit pressure during extrusion, which can provide various process advantages.

Some MOFs may form extrudates having high crush strengths that exceed a predetermined value. The predetermined value may be selected based upon a chosen application in which the extrudates are to be used, including tolerance of the application to the presence of fines. For example, certain extrudates of the present disclosure may be formed such that their crush strengths are about 30 lb/in or greater or 50 lb/ft or greater, which may limit fines production in some cases. These crush strengths may be converted into Newtons by dividing by a factor of 1.8. In some cases, a binder additive may be combined with the MOF powder material prior to extrusion in order to achieve crush strengths of this magnitude. Although the overall surface area of the extrudate may decrease when using a binder additive, the surface area of the MOF itself may remain unchanged or change no more than if the binder additive were not present (i.e., by measuring the normalized surface area contribution of the MOF in the extrudate). Thus, binder additives may facilitate use of MOF's that form extrudates having insufficient crush strengths alone. In other cases, however, self-supported extrudates (i.e., an extrudate lacking a separate binder additive) having high crush strengths may be produced according to the disclosure herein. Even in cases where low crush strengths are obtained, the extrudates of the present disclosure may still exhibit sufficient mechanical stability for use in various applications.

Methods fir producing the extrudates of the present disclosure involve agitating a mixture of a pre-crystallized MOF powder material and a solvent to form a dough or paste that is suitable for extrusive processing. Agitation may occur by mulling in some instances. Mulling is distinguished from milling in that mulling does not apply a constant pressure and is gentler in terms of a lesser amount of force (energy) being applied during mixing. Mulling generally does not impart sufficient energy to the MOF to promote complete conversion of the MOF structure into another crystalline phase. Some MOFs may be unstable toward input of even modest amounts of energy, and formation of a minor new crystalline phase may still occur even under the gentle mulling conditions disclosed herein. In some cases, the phase transformation may be arrested by suitable choice of the mulling solvent, as discussed above.

Before describing the extrudates and extrusion methods of the present disclosure in further detail, a listing of terms follows to aid in better understanding the present disclosure.

All numerical values within the detailed description and the claims herein are modified by “about” or “approximately” with respect to the indicated value, and take into account experimental error and variations that would be expected by a person having ordinary skill in the art. Unless otherwise indicated, room temperature is about 25° C.

As used in the present disclosure and claims, the singular forms “a,” “an,” and “the” include plural forms unless the context clearly dictates otherwise.

The term “and/or” as used in a phrase such as “A and/or B” herein is intended to include “A and B,” “A or B,” “A”, and “B.”

For the purposes of the present disclosure, the new numbering scheme for groups of the Periodic Table is used. In said numbering scheme, the groups (columns) are numbered sequentially from left to right from 1 through 18, excluding the f-block elements (lanthanides and actinides).

As used herein, the term “aqueous medium” refers to a liquid comprising 5 vol. % water or greater. Suitable aqueous media may comprise or consist essentially of water or mixtures of water and a water-miscible organic solvent.

As used herein, the term “extrusion” refers to the process of pushing a fluidized material mix through a die having a desired cross-section. The term “extrudate” refers to an elongate body produced during extrusion.

As used herein, the term “consolidated” refers to the process of fusing two or more smaller bodies into the form of a larger body.

As used herein, the term “pre-crystallized” refers to a material, particularly a metal-organic framework material, that is previously synthesized (pre-formed) and typically separated from a reaction medium in which the material was formed.

As used herein, the term “paste” refers to a solvated powder having a dough-like appearance and consistency. The term “paste” does not imply an adhesive function.

Accordingly, extrudates of the present disclosure may comprise: a metal-organic framework consolidated material formed by extrusion of a mull comprising a pre-crystallized metal-organic framework powder material. The metal-organic framework consolidated material has a BET surface area of about 50% or greater relative to that of the pre-crystallized metal-organic framework powder material, and x-ray powder diffraction of the extrudate shows about 20% or less conversion of the pre-crystallized metal-organic framework powder material into a different phase within the metal-organic framework consolidated material following extrusion, as measured by peak intensity of one or more x-ray powder diffraction peaks. More particular examples may feature metal-organic framework consolidated materials having a BET surface area of about 80% or greater relative to that of the metal-organic powder material or about 90% or greater relative to that of the metal-organic framework powder material. It is to be emphasized that the BET surface areas herein are measured relative to the metal-organic framework powder material from which the mull was produced, but not other materials present in the mull. That is, when other porous materials are present in the extrudate (e.g., a binder additive), calculated BET surface areas are normalized to correct (remove) the surface area contribution of the other porous materials from the overall BET surface area.

The metal-organic framework consolidated materials disclosed herein may be characterized in terms of their porosity. The metal-organic framework consolidated materials may include micropores, mesopores, macropores and any combination thereof. Micropores are defined herein as having a pore size of about 2 nm or below, and mesopores are defined herein as having a pore size from about 2 nm to about 50 nm. Interparticle textural porosity may be present in some instances. Determination of microporosity and/or mesoporosity may be determined by analysis of the nitrogen adsorption isotherm at 77 K, as will be understood by one having ordinary skill in the art.

Desirably, extrudates formed according to the disclosure herein may retain at least a substantial majority of the BET surface area of the pre-crystallized metal-organic framework powder material from which they are formed. Specifically the metal-organic framework consolidated material within the extrudates may feature a BET surface area of about 50%, 60%, 70%, 80%, 90% or greater relative to the BET surface area of the pre-crystallized metal-organic framework powder material. Advantageously and surprisingly in some instances, the BET surface area of the metal-organic framework consolidated material within the extrudates may even be greater than the BET surface area of the pre-crystallized metal-organic framework powder material. Pelletized samples may feature similar BET surface areas of the metal-organic framework consolidated material.

The extrudates formed according to the disclosure here may be self-supported (i.e., consist essentially of the metal-organic framework consolidated material), or they may include a binder additive (i.e., consist essentially of the metal-organic framework consolidated material and the binder additive). That is, some extrudates formed according to the disclosure herein may comprise a binder additive that is present in the mull and is co-extruded when forming the metal-organic framework consolidated material. When present, the binder additive may desirably improve the mechanical properties of the extrudates. Specifically, suitable binder additives may increase the crush strengths of the extrudates formed according to the disclosure herein, Pelletized samples may similarly feature a binder additive or be self-supported.

The amount of binder additive that is present in the mull may vary over a wide range. For example, in various embodiments, the mull may comprise about 0.5% to about 90% of the binder additive as a percent of total solids in the mull. Other suitable amounts of the binder additive may include, for example, about 5% to about 90%, or about 10% to about 70%, or about 20% to about 60% of the total solids in the mull.

Binder additives that may be employed in the disclosure herein are not considered to be particularly limited. Selection of a suitable binder additive may depend upon various factors including, for example, the identity of the pre-crystallized metal-organic framework powder material, a target crush strength of the extrudate, and the intended application where the extrudate will be used. Binder additives that may be suitable for use in the disclosure herein include, for example, a clay, a polymer, an oxide powder, a biopolymer, and any combination thereof. Specific examples of binder additives that may be suitable for use in the disclosure herein include, for example, titanium dioxide, zirconium oxide, alumina, silica, other metal oxides, clays and other aluminosilicates, alkoxysilanes, graphite, cellulose or cellulose derivatives, the like, and any combination thereof. Binder additives that may be particularly suitable for use in forming the extrudates of the present disclosure include, for example, montmorillonite, kaolin, alumina, silica, and any combination thereof. Such binder additive may be employed similarly in pelletized samples.

A target crush strength for the extrudates of the present disclosure may be selected based upon particular application needs (e.g., tolerance of the application to fines) and the relative propensity of the pre-crystallized metal-organic framework powder material to form an extrudate that is stable toward crush forces. Some pre-crystallized metal-organic framework powder materials, for instance, may inherently form extrudates having low crush strengths, even when employing the disclosure herein, including use of a binder additive. Accordingly, some extrudates of the present disclosure may exhibit crush strengths of about 30 lb/in or greater, since such crush strengths are less likely to lead to production of fines during use. Other extrudates of the present disclosure may exhibit crush strengths of 50 lb/in or greater. In specific embodiments, suitable crush strengths may range from about 30 lb/in to about 135 lb/in, or about 30 lb/in to about 100 lb/in, or about 50 lb/in to about 100 lb/in, or about 60 lb/in to about 90 lb/in, or 55 lb/in to about Particular crush strengths may vary based upon the identity of the pre-crystallized metal-organic framework powder material and whether a binder additive is present. Therefore, extrudates having crush strengths below the target value of 30 lb/in also reside within the scope of the present disclosure. Extrudates having lower crush strengths may be suitable for use in gas applications, for example. Pelletized samples may have crush strengths residing within similar ranges to those disclosed above.

Pre-crystallized metal-organic framework powder materials that may undergo extrusion and consolidation according to the present disclosure are likewise not considered to be particularly limited. Suitable metal-organic framework powder materials may include, but are not limited to a trimesate, a terephthalate, an imidazolate, and any combination thereof. Particular pre-crystallized metal-organic framework powder materials are referenced herein by their common names, rather than by a detailed chemical name or description of their composition. Such common names will be familiar to one having ordinary skill in the art. Illustrative pre-crystallized metal-organic framework powder materials that may undergo extrusion and consolidation according to the present disclosure include, for example, HKUST-1, ZIF-7, ZIF-8, and UiO-66. Such metal-organic framework powder materials may likewise be present in pelletized samples.

Methods are also described herein for forming the extrudates of the present disclosure. Advantageously, the methods may be conducted under conditions selected such that the extrudates may be obtained with substantial retention of the surface area and the crystalline phase originally present in the pre-crystallized metal-organic framework powder material. In certain instances, extruding the pre-crystallized metal-organic framework powder material in the presence of a solvent used in conjunction with synthesizing the pre-crystallized metal-organic framework powder material may be beneficial. In some configurations, extruding the pre-crystallized metal-organic framework powder material in the presence of an alcohol may be advantageous for stabilizing the crystalline phase originally present in the pre-crystallized metal-organic framework powder material. Some alcohol solvents may also desirably lower the pressure during extrusion. Other polar solvents may provide similar stabilization effects for metal-organic framework materials during extrusion as well.

Accordingly, certain methods of the present disclosure may comprise: combining a pre-crystallized metal-organic framework powder material with a solvent, the solvent comprising one or more solvents used to form the metal-organic framework powder material; mixing the pre-crystallized metal-organic framework powder material with the solvent to form a mulled metal-organic framework paste; and extruding the mulled metal-organic framework paste to form an extrudate comprising a metal-organic framework consolidated material. Mixing is conducted such that about 20% or less of the pre-crystallized metal-organic framework powder material is transformed into a different phase, as determined by x-ray powder diffraction. The metal-organic framework consolidated material has a BET surface area of about 50% or greater relative to that of the pre-crystallized metal-organic framework powder material, and x-ray powder diffraction of the extrudate shows about 20% or less conversion of the pre-crystallized metal-organic framework powder material into a different phase within the metal-organic framework consolidated material following extrusion, as measured by peak intensity of one or more x-ray powder diffraction peaks. More particular examples may feature metal-organic framework consolidated materials having a BET surface area of about 80% or greater relative to that of the metal-organic powder material or about 90% or greater relative to that of the metal-organic framework powder material.

In the embodiments of the present disclosure, mixing of the pre-crystallized metal-organic framework powder material and the solvent may take place by mulling. Various mulling devices may be used for this purpose. Other mixing techniques, such as planetary mixers and the like may similarly produce a mulled metal-organic framework paste suitable for producing an extrudate or pellet that at least partially retains the properties of the metal-organic framework powder material.

In some cases, the solvent employed in the methods of the present disclosure may comprise an alcohol or an alcohol; water mixture. The alcohol may be water-soluble (including partially water-soluble) in particular embodiments. Suitable water-soluble alcohols may include, for example, methanol, ethanol, 1-propanol, 2-propanol, 1-butanol, 2-butanol, t-butanol, ethylene glycol, propylene glycol, glycerol, and any combination thereof. Other alcohols having lower or negligible water solubility that also may be suitable used include, for example, 1-pentanol, 1-hexanol, 1-octanol, 1-decanol, cyclohexanol, the like, and any combination thereof. Alcohols having lower or negligible water solubility may be combined with one or more alcohols having higher water solubility as a co-solvent (e.g., methanol, ethanol, or the like) or other water-miscible organic solvents such as acetone, tetrahydrofuran, ethylene glycol, glycol ethers, or the like.

Other aqueous solvents may also be employed in the disclosure herein, including water, mixtures of water and salts or neutral compounds, or mixtures of water with one or more water-miscible organic solvents.

Pre-crystallized metal-organic framework powder materials that may be extruded according to the disclosure herein are not considered to be particularly limited. In particular embodiments, the pre-crystallized metal-organic framework powder material may be selected from among HKUST-1, ZIF-7, ZIF-8, and UiO-66. Alcohols, particularly ethanol, may aid in stabilizing the crystalline phase of HKUST-1 during extrusion.

As indicated above, the extrudates of the present disclosure may or may not include a binder additive when undergoing extrusion. Accordingly, in particular embodiments, the mulled metal-organic framework paste may comprise or consist essentially of the pre-crystallized metal-organic framework powder material and the solvent. In other embodiments, however, the mulled metal-organic framework paste may comprise or consist essentially of the pre-crystallized metal-organic framework powder material, a binder additive, and the solvent. The binder additive is retained in the extrudate following extrusion. Pelletized samples may similarly incorporate a hinder additive in some cases.

Once extruded, methods of the present disclosure may further comprise taking further actions to remove the solvent from the extrudate after extrusion. Solvent removal may be accomplished, for example, by heating the extrudate, placing the extrudate under vacuum or a similar reduced pressure environment, or any combination thereof. In particular embodiments, heating of the extrudate may be conducted at a temperature up to about 300° C. Selection of a suitable temperature and/or pressure condition to affect solvent removal may depend upon the boiling point of the solvent to be removed and the thermal stability of the metal-organic framework. When performed, heating may also at least partially aid in consolidation of particulates within the metal-organic framework powder material if not completely consolidated during extrusion.

The mulled metal-organic framework paste may comprise a suitable loading of solids to promote extrusion or pelletization. In particular embodiments, the mulled metal-organic framework paste may comprise about 35% to about 70% solids, or about 40% to about 60% solids, or about 35% to about 55% solids. When present, a binder additive is included in the foregoing solid contents.

Some or other methods of the present disclosure may comprise: combining a pre-crystallized metal-organic framework powder material with a solvent selected from the group consisting of an alcohol and an alcohol/water mixture; mixing the pre-crystallized metal-organic framework powder material with the solvent to form a mulled metal-organic framework paste; and extruding the mulled metal-organic framework paste to form an extrudate comprising a metal-organic framework consolidated material. Mixing is conducted such that about 20% or less of the pre-crystallized metal-organic framework powder material is transformed into a different phase, as determined by x-ray powder diffraction. The metal-organic framework consolidated material has a BET surface area of about 50% or greater relative to that of the pre-crystallized metal-organic framework powder material, and x-ray powder diffraction of the extrudate shows about 20% or less conversion of the pre-crystallized metal-organic framework powder material into a different phase within the metal-organic framework consolidated material following extrusion, as measured by peak intensity of one or more x-ray powder diffraction peaks. More particular examples may feature metal-organic framework consolidated materials having a BET surface area of about 80% or greater relative to that of the metal-organic powder material or about 90% or greater relative to that of the metal-organic framework powder material. Mixing of the pre-crystallized metal-organic framework powder material and the solvent may take place by mulling, in some embodiments.

Although the disclosure above is primarily directed to extrusion of metal-organic framework powder materials, it is to be appreciated that shaped bodies comprising a metal-organic framework consolidated material may be prepared by alternative arrangements as well. For example, according to some embodiments, metal-organic framework consolidated materials may be prepared by compacting a mulled metal-organic framework paste similar to that described above. Suitable compaction techniques may include application of hydraulic pressure to form pelletized samples, in some embodiments.

Accordingly, alternative embodiments of the present disclosure may provide a compacted body, possibly in pelletized form, comprising: a metal-organic framework consolidated material formed by compacting under hydraulic pressure a mull comprising a pre-crystallized metal-organic framework powder material. The metal-organic framework consolidated material has a BET surface area of about 50% or greater relative to that of the pre-crystallized metal-organic framework powder material, and x-ray powder diffraction of the compacted body shows about 20% or less conversion of the pre-crystallized metal-organic framework powder material into a different phase within the metal-organic framework consolidated material following compaction, as measured by peak intensity of one or more x-ray powder diffraction peaks. More particular examples may feature metal-organic framework consolidated materials having a BET surface area of about 80% or greater relative to that of the metal-organic powder material or about 90% or greater relative to that of the metal-organic framework powder material.

Any of the metal-organic framework powder materials and solvents described hereinabove for forming an extrudate may similarly be used to form a consolidated body by application of hydraulic pressure, Alcohols may be particularly suitable as a mulling solvent in some cases.

Suitable hydraulic pressures for compacting the metal-organic framework powder material in a mull comprising a suitable solvent may range from about 100 psi to about 50,000 psi, or about 200 psi to about 10,000 psi, or about 500 psi to about 5,000 psi. Compaction times may range from about 10 seconds to about 1 hour, or about 30 seconds to about 10 minutes, or about 1 minute to about 5 minutes.

In some embodiments, heat may be applied while forming a compacted body by applying hydraulic pressure. Temperatures may range from about 30° C. to about 150° C., or about 40° C. to about 120° C., or about 50° C. to about 100° C.

Accordingly, methods for forming a consolidated body by application of hydraulic pressure to a mulled metal-organic framework paste may comprise: combining a pre-crystallized metal-organic framework powder material with a solvent, the solvent comprising one or more solvents used to form the metal-organic framework powder material; mixing the pre-crystallized metal-organic framework powder material with the solvent to form a mulled metal-organic framework paste; and applying hydraulic pressure to the mulled metal-organic framework paste to form an consolidated body comprising a metal-organic framework consolidated material. Mixing is conducted such that about 20% or less of the pre-crystallized metal-organic framework powder material is transformed into a different phase, as determined by x-ray powder diffraction. The metal-organic framework consolidated material has a BET surface area of about 50% or greater relative to that of the pre-crystallized metal-organic framework powder material, and x-ray powder diffraction of the extrudate shows about 20% or less conversion of the pre-crystallized metal-organic framework powder material into a different phase within the metal-organic framework consolidated material following compaction, as measured by peak intensity of one or more x-ray powder diffraction peaks. More particular examples may feature metal-organic framework consolidated materials having a BET surface area of about 80% or greater relative to that of the metal-organic powder material or about 90% or greater relative to that of the metal-organic framework powder material.

Other methods for forming a consolidated body by application of hydraulic pressure to a mulled metal-organic framework paste may comprise: combining a pre-crystallized metal-organic framework powder material with a solvent selected from the group consisting of an alcohol and an alcohol/water mixture; mixing the pre-crystallized metal-organic framework powder material with the solvent to form a mulled metal-organic framework paste; and applying hydraulic pressure to the mulled metal-organic framework paste to form a consolidated body comprising a metal-organic framework consolidated material. Mixing is conducted such that about 20% or less of the pre-crystallized metal-organic framework powder material is transformed into a different phase, as determined by x-ray powder diffraction. The metal-organic framework consolidated material has a BET surface area of about 50% or greater relative to that of the pre-crystallized metal-organic framework powder material, and x-ray powder diffraction of the extrudate shows about 20% or less conversion of the pre-crystallized metal-organic framework powder material into a different phase within the metal-organic framework consolidated material following compaction, as measured by peak intensity of one or more x-ray powder diffraction peaks. More particular examples may feature metal-organic framework consolidated materials having a BET surface area of about 80% or greater relative to that of the metal-organic powder material or about 90% or greater relative to that of the metal-organic framework powder material. Mixing of the pre-crystallized metal-organic framework powder material and the solvent may take place by mulling, in some embodiments.

Embodiments disclosed herein include:

A. MOF extrudates. The extrudates comprise: a metal-organic framework consolidated material formed via extrusion of a mull comprising a pre-crystallized metal-organic framework powder material; wherein the metal-organic framework consolidated material has a BET surface area of about 50% or greater relative to that of the pre-crystallized metal-organic framework powder material, and x-ray powder diffraction of the extrudate shows about 20% or less conversion of the pre-crystallized metal-organic framework powder material into a different phase within the metal-organic framework consolidated material following extrusion, as measured by peak intensity of one or more x-ray powder diffraction peaks.

B. Methods for extruding a MOF. The methods comprise: combining a pre-crystallized metal-organic framework powder material with a solvent, the solvent comprising one or more solvents used to form the pre-crystallized metal-organic framework powder material; mixing the pre-crystallized metal-organic framework powder material with the solvent to form a mulled metal-organic framework paste; wherein mixing is conducted such that about 20% or less of the pre-crystallized metal-organic framework powder material is transformed into a different phase, as determined by x-ray powder diffraction; and extruding the mulled metal-organic framework paste to form an extrudate comprising a metal-organic framework consolidated material; wherein the metal-organic framework consolidated material has a BET surface area of about 50% or greater relative to that of the pre-crystallized metal-organic framework powder material, and x-ray powder diffraction of the extrudate shows about 20% or less conversion of the pre-crystallized metal-organic framework powder material into a different phase within the metal-organic framework consolidated material following extrusion, as measured by peak intensity of one or more x-ray powder diffraction peaks.

C. Methods for extruding a MOF in the presence of an alcohol. The methods comprise: combining a pre-crystallized metal-organic framework powder material with a solvent selected from the group consisting of an alcohol and an alcohol/water mixture; mixing the pre-crystallized metal-organic framework powder material with the solvent to form a mulled metal-organic framework paste; wherein mixing is conducted such that about 20% or less of the pre-crystallized metal-organic framework powder material is transformed into a different phase, as determined by x-ray powder diffraction; and extruding the mulled metal-organic framework paste to form an extrudate comprising a metal-organic framework consolidated material; wherein the metal-organic framework consolidated material has a BET surface area of about 50% or greater relative to that of the pre-crystallized metal-organic framework powder material, and x-ray powder diffraction of the extrudate shows about 20% or less conversion of the pre-crystallized metal-organic framework powder material into a different phase within the metal-organic framework consolidated material following extrusion, as measured by peak intensity of one or more x-ray powder diffraction peaks.

Embodiments A-C may have one or more of the following additional elements in any combination:

Element 1: wherein the metal-organic framework consolidated material has a BET surface area of about 80% or greater relative to that of the pre-crystallized metal-organic framework powder material.

Element 2: wherein the metal-organic framework consolidated material has a BET surface area of about 90% or greater relative to that of the pre-crystallized metal-organic framework powder material.

Element 3: wherein the extrudate further comprises: a binder additive that is present in the mull and is co-extruded when forming the metal-organic framework consolidated material.

Element 4: wherein the binder additive is selected from the group consisting of a clay, a polymer, an oxide powder, and any combination thereof.

Element 5: wherein the binder additive is selected from the group consisting of montmorillonite, kaolin, alumina, silica, any combination thereof.

Element 6: wherein the pre-crystallized metal-organic framework powder material is selected from the group consisting of a trimesate, a terephthalate, an imidazolate, and any combination thereof.

Element 7: wherein the pre-crystallized metal-organic framework powder material is selected from the group consisting of HKUST-1, ZIF-7, ZIF-8, and UiO-66.

Element 8: wherein the BET surface area of the metal-organic framework consolidated material is greater than the BET surface area of the pre-crystallized metal-organic framework powder material.

Element 9: wherein the extrudate has a crush strength of about 30 lb/in or greater.

Element 10: wherein the extrudate consists essentially of the metal-organic framework consolidated material.

Element 11: wherein mixing comprises mulling the pre-crystallized metal-organic framework powder material with the solvent.

Element 12: wherein the solvent comprises an alcohol.

Element 13: wherein the solvent comprises an alcohol/water mixture.

Element 14: wherein the alcohol comprises ethanol.

Element 15: wherein the pre-crystallized metal-organic framework powder material comprises HKUST-1.

Element 16: wherein the solvent comprises an aqueous solvent.

Element 17: wherein the aqueous solvent comprises a mixture of water and a water-miscible alcohol.

Element 18: wherein the method further comprises: heating the extrudate after extrusion.

Element 19: wherein the mulled metal-organic framework paste consists essentially of the pre-crystallized metal-organic framework powder material and the solvent.

Element 20: wherein the mulled metal-organic framework paste consists essentially of the pre-crystallized metal-organic framework powder material, a binder additive, and the solvent; wherein the binder additive is retained in the extrudate.

By way of non-limiting example, exemplary combinations applicable to A include 1 or 2 and 3; 1 or 2 and 4; 1 or 2 and 5; 1 or 2 and 6; 1 or 2 and 7; 1 or 2 and 8; 1 or 2 and 9; 1 or 2 and 10; 3 and 4; 3 and 5; 3 and 6; 3 and 7; 3 and 8; 3 and 9; 3 and 10; 6 and 8; 6 and 9; 6 and 10; 7 and 8; 7 and 9; 7 and 10; 8 and 9; 8 and 10; and 9 and 10. Exemplary combinations applicable to B include 1 or 2 and 11; 1 or 2 and 6; 1 or 2 and 7; 1 or 2 and 8; 1 or 2 and 9; 1 or 2 and 10; 1 or 2 and 12; 1 or 2 and 13; 1 or 2 and 16; 1 or 2 and 17; 1 or 2 and 18; 1 or 2 and 19; 1 or 2 and 20; 11 and 12; 11 and 13; 11 and 18; 11 and 19; 11 and 20; 12 or 13 and 15; 12 or 13 and 18; 12 or 13 and 19; 12 or 13 and 20; 16 or 17 and 18; 16 or 17 and 18; 16 or 17 and 19; 16 or 17 and 20; 4 and 20; and 5 and 20. Exemplary combinations applicable to C include 1 or 2 and 3; 1 or 2 and 4; 1 or 2 and 5; 1 or 2 and 6; 1 or 2 and 7; 1 or 2 and 8; 1 or 2 and 9; 1 or 2 and 10; 1 or 2 and 11; 1 or 2 and 14; 1 or 2 and 14 and 15; 1 or 2 and 18; 1 or 2 and 19; 1 or 2 and 20; 3 and 4; 3 and 5; 3 and/or 4 and/or 5 and 6; 3 and/or 4 and/or 5 and 7; 3 and/or 4 and/or 5 and 8; 3 and/or 4 and/or 5 and 9; 3 and/or 4 and/or 5 and 10; 3 and/or 4 and/or 5 and 11; 3 and/or 4 and/or 5 and 14; 3 and/or 4 and/or 5 and 14 and 15; 3 and/or 4 and/or 5 and 18; 3 and/or 4 and/or 5 and 19; 3 and/or 4 and/or 5 and 20; 6 or 7 and 8; 6 or 7 and 9; 6 or 7 and 10; 6 or 7 and 11; 6 or 7 and 14; 6 or 7 and 14 and 15; 6 or 7 and 18; 6 or 7 and 19; 6 or 7 and 20; 8 and 9; 8 and 10; 8 and 11; 8 and 14; 8, 14 and 15; 8 and 18; 8 and 19; 8 and 20; 9 and 10; 9 and 11; 9 and 14; 9, 14 and 15; 9 and 18; 9 and 19; 9 and 20; 10 and 11; 10 and 14; 10, 14 and 15; 10 and 18; 10 and 19; 10 and 20; 11 and 14; 11, 14 and 15; 11 and 18; 11 and 19; 11 and 20; 14 and 15; 14 and 18; 14 and 19; 14 and 20; 18 and 19; 18 and 20; 4 and 20; 5 and 20.

To facilitate a better understanding of the embodiments described herein, the following examples of various representative embodiments are given. In no way should the following examples be read to limit, or to define, the scope of the present disclosure.

### EXAMPLES

Four representative MOFs were chosen for extrusion in the following examples: HKUST-1 [Cu₃(BTC)₂; BTC=1,3,5-benzenetricarboxylate], ZIF-7 [Zn(bnz)₂; bnz=benzimidazolate], ZIF-8 [Zn(MeIm)₂; MeIm=2-methylimidazolate], and UiO-66 [Zr₆O₄(OH)₄(bdc)₆; bdc=1,4-benzenedicarboxylate]. These MOFs were chosen based upon a variety of factors, including: commercial availability (HKUST-1 and UiO-66), high thermal stability and connectivity (ZIF-7 and UiO-66), flexibility and sodalite topology (ZIF-7), and being widely studied (all). HKUST-1 was either purchased from Sigma Aldrich or synthesized by stirring Cu(OH)₂ and 1,3,5-benzenetricarboxylic acid in ethanol/water overnight and filtering to obtain the product. ZIF-7 was synthesized by stirring Zn(OAc)₂.2H₂O and benzimidazole with 30% aqueous ammonium hydroxide in ethanol for 3-5 hours and filtering to obtain the product. ZIF-8 was purchased from Sigma Aldrich. UiO-66 was purchased from Strem Chemicals.

X-ray powder diffraction data was obtained using Cu K-α radiation.

Extrusion was conducted in the following examples using a single die extruder (typically 1/16″ cylinders) and a Carver hand press, unless otherwise noted below. As noted below, some HKUST-1 samples were extruded with a 1″ screw extruder.

Extrusion was conducted by first forming a mull and then loading the mull into the extruder. Unless otherwise noted below, solids were weighed out and placed in a mortar. To the solids were then added water, ethanol, a higher alcohol, or a pre-made water/ethanol solution. For HKUST-1, the solvent was added from a spray bottle, mulling with a pestle after every few sprays until all of the liquid had been added. For ZIF-7, ZIF-8, and UiO-66, the solvent was added from a dropper. Once the mull had been formed, the mull was then placed in extruder.

Initial pelletization experiments were conducted for some of the MOFs, with conditions for pelletization being described below.

BET surface areas in the examples below were determined from N₂ adsorption isotherms obtained at 77 K. Nitrogen adsorption isotherms were measured using a Tristar II analyzer (Micromeritics) at 77 K. Before measurement, the samples were degassed at 150° C. to a constant pressure of 10⁻⁵ torr for 4 hours. The surface area was then measured by the amount of N₂ adsorbed onto the surface of the sorbate. Regression analysis was then applied to the data, resulting in an isotherm. The isotherms were used to calculate the specific surface area, micropore volume, and pore size distribution.

### Example 1: HKUST-1

Commercial HKUST-1 had a crystallite size of approximately 10 μm and a BET surface area of 1766 m²/g. Batches of synthesized HKUST-1 had BET surface areas ranging from 1736 m²/g to 1950 m²/g and a crystallite size of approximately 0.5

Pelletization Experiments.

Pelletization of HKUST-1 was conducted initially as a surrogate of extrusion. Dried (oven heat-activated at 120° C.) and solvated (undried, as-synthesized) samples of HKUST-1 were compacted for 1 minute in a hydraulic press at pressures of 250, 500, 1000 and 10000 psi. The HKUST-1 was in powder form when subjected to pelletization pressures. No solvent was included for the pelletization experiments.

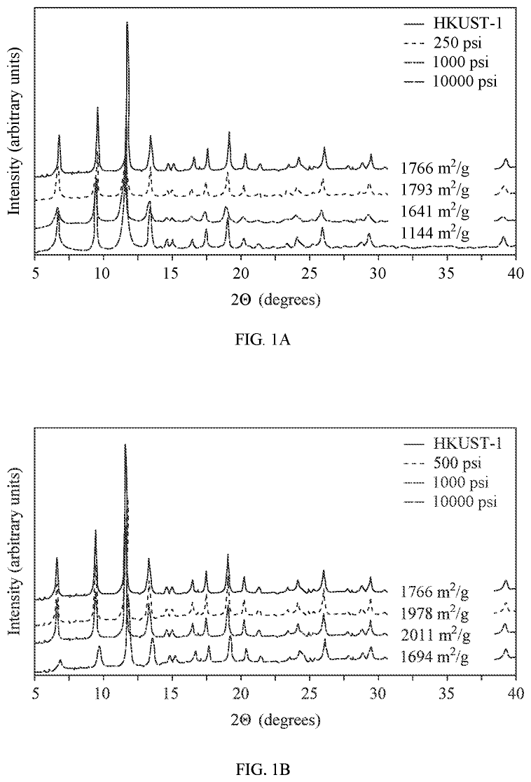

FIGS. 1A and 1B show x-ray powder diffraction data for native HKUST-1 and HKUST-1 samples pelletized at various hydraulic pressures. The samples in FIG. 1A were dried (oven heat-activated at 120° C.) to remove remaining traces of the reaction solvent prior to pelletization. In contrast, the samples in FIG. 1B were pelletized using the as-synthesized MOF powder material and still contained trace solvent residue (water-ethanol). As shown in FIGS. 1A and 1B, the pellets formed from as-synthesized (solvent-containing) HKUST-1 powder showed better crystallinity retention following pelletization, as determined by comparison of the x-ray powder diffraction data. The mechanical strength of the pellets formed from as-synthesized HKUST-1 also appeared to be superior to that of the pellets formed from dried HKUST-1.

In general, the pellets formed from as-synthesized HKUST-1 also exhibited higher BET surface areas than did those formed from dried HKUST-1 (values shown in FIGS. 1A and 1B for each pellet). Surprisingly, the pellets formed from as-synthesized HKUST-1 at 500 psi and 1000 psi exhibited significantly higher BET surface areas (˜+13.8%) than did the HKUST-1 powder material. At 10000 psi, in contrast, the BET surface area of the pellet decreased somewhat compared to the HKUST-1 powder material. Pellets formed from dried HKUST-1, in contrast, exhibited lower BET surface areas at both 1000 psi and 10000 psi compared to the corresponding HKUST-1 powder material. Without being bound by theory or mechanism, the increased BET surface areas of the pellets formed from as-synthesized HKUST-1 are believed to arise due to the solvent leading to increased microporosity following pelletization. Thus, the pelletization experiments demonstrated a surprising increase in BET surface area values when as-synthesized HKUST-1 (loaded with water-ethanol) were pelletized at pressures up to at least 1000 psi.

Independent pelletization experiments conducted with HKUST-1 loaded with only water or only ethanol did not afford a similar increase in BET surface area following pelletization. Specifically, an ethanol-loaded HKUST-1 sample, from which water had been previously removed by drying (121° C. heating) followed by ethanol exchange, experienced a decrease in BET surface area from 2041 m²/g to 1660 m²/g following pelletization at 1000 psi. Water-loaded HKUST-1 samples, from which water had been previously removed and then reintroduced by rehydration, showed BET surface areas ranging from 1643-1695 m²/g when pelletized at 1000 psi, which are lower than that of the HKUST-1 powder material.

Extrusion Experiments.

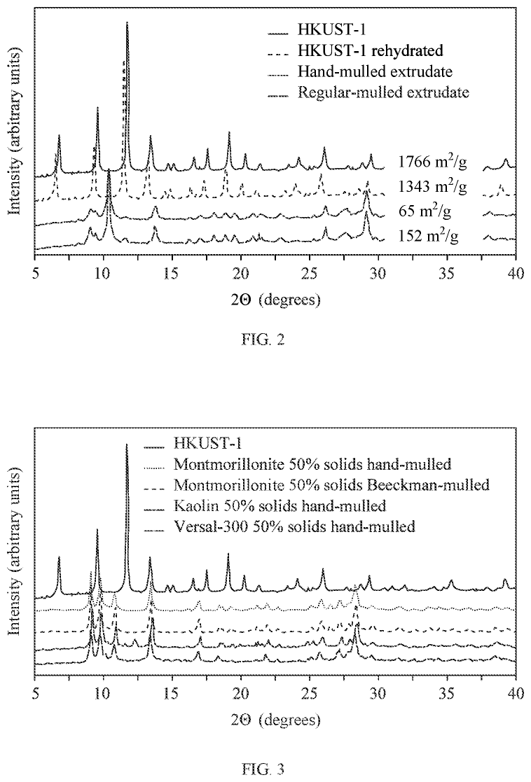

Initial extrusion experiments for HKUST-1 were conducted using a 1″ Diamond America extruder. Dried HKUST-1 was combined with water, and the mixture was mulled and subsequently extruded. The resulting x-ray powder diffraction pattern showed full conversion of the HKUST-1 into another phase and a decrease in the BET surface area. Mulling only (no extrusion) of HKUST-1, both in the extruder and by hand grinding in a mortar and pestle, resulted in a significant decrease in the BET surface area that increased in magnitude over time. Subsequent extrusion, in addition to further lowering the BET surface area, resulted in a phase change, as shown in FIG. 2. Addition of various binder additives, such as montmorillonite clay, kaolin, or VERSAL 300 (alumina, UOP) similarly failed to arrest the phase change of HKUST-1 during mulling, as shown in FIG. 3.

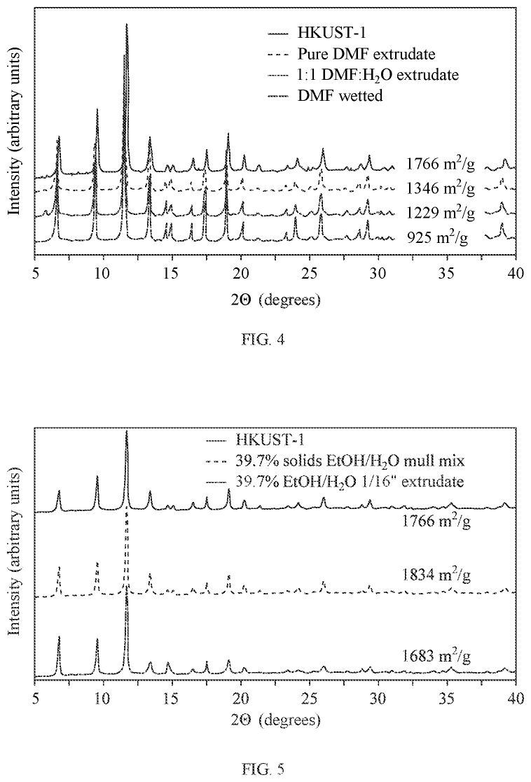

Mulls containing N,N-dimethylformamide (DMF) or 1:1 water:DMF as a solvent instead of water alone, and extrudates formed therefrom, retained a crystalline HKUST-1 phase but demonstrated decreased BET surface area values, as shown in FIG. 4. A marginal decrease in crystallinity occurred in the extruded samples formed in the presence of DMF or water:DMF. The samples extruded in the presence of DMF or water:DMF could not be activated by heating in an oven.

Subsequent extrusion experiments for HKUST-1 were conducted with a Carver hand press and single-die extruder, as described above, using a mull formed from a water:ethanol mixture. In contrast to water alone, DMF alone, or water:DMF mixtures, inclusion of a water:ethanol mixture in the mull led to retention of both the HKUST-1 phase and the BET surface area following mulling and extrusion, as described hereinafter.

HKUST-1 was combined with a 1:1 water:ethanol (v/v) mixture at a solids content of 39.7% by weight and mulled by hand. Initially, no binder additive was included when mulling the HKUST-1 with the solvent mixture. The mull formed at 39.7% HKUST-1 loading was extrudable over a pressure range of about 1000-2000 psi. Formation of an extrudate with commercial HKUST-1 was difficult, likely due to the larger crystallite size. After mulling, the surface area of the mull was 1834 m²/g, and following extrusion, the surface area of a 1/16″ extrudate was 1683 m²/g. As shown in FIG. 5, the HKUST-1 phase was largely retained in both the mulled mixture and the extrudate. Only a minor change in peak shape was observed at a 20 value of 15°. Extrusion of a sample mulled with ethanol alone similarly maintained the BET surface area at acceptable levels (1675 m²/g; data not shown).

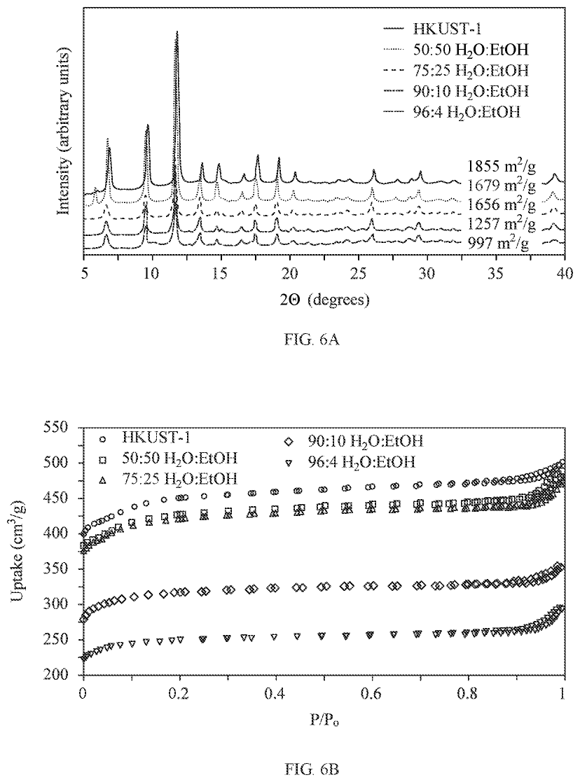

The amount of ethanol used for mulling and extrusion also influenced the resulting BET surface area of the extrudates. FIG. 6A shows comparative x-ray powder diffraction and BET surface area data for HKUST-1 extrudates formed from mulls containing various ratios of water:ethanol. FIG. 6B shows comparative N₂ adsorption isotherms for HKUST-1 extrudates formed from mulls containing various ratios of water:ethanol. Even at an ethanol content of 4%, the HKUST-1 phase was largely retained, thereby showing the powerful effect of this solvent on stabilizing HKUST-1 during extrusion. At water:ethanol ratios of 1:1 and 1:3, the surface area of the extrudate was only marginally decreased from that of native HKUST-1 (˜90% of the initial HKUST-1 BET surface area value). Even with the significant BET surface area reduction at an ethanol content of 4%, the observed BET surface area was still significantly higher when only water was present (>50% BET surface area retention with 4% ethanol compared to <5% BET surface area retention with 100% water).

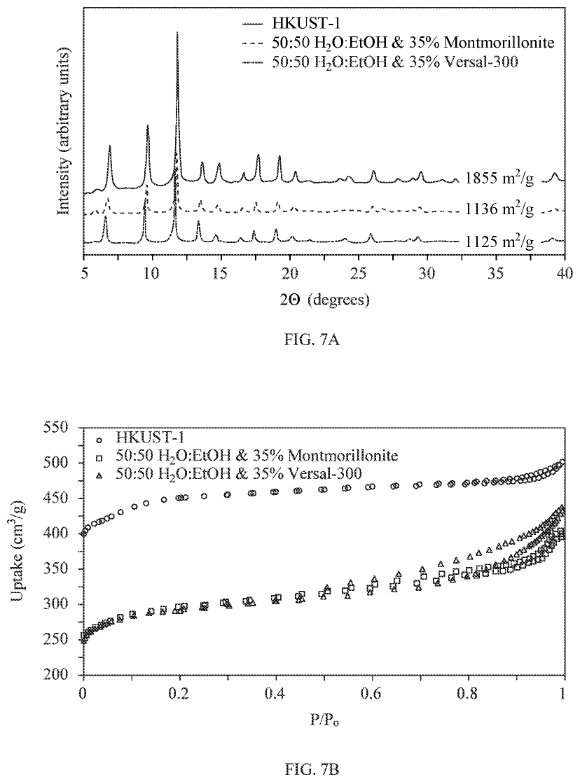

Montmorillonite K10 and VERSAL 300 were also suitably combined with HKUST-1 as a binder additive in water:ethanol mulls. In particular, HKUST-1 was combined at a ratio of 65:35 (w/w) HKUST-1:binder additive in 1:1 water:ethanol and mulled and extruded as described above. Following extrusion, the x-ray powder diffraction pattern of HKUST-1 was still evident. FIG. 7A shows comparative x-ray powder diffraction and BET surface area data for HKUST-1 extrudates formed from mulls containing various binder additives. The crystallinity appeared to be significantly higher for the VERSAL 300 sample compared to that of the montmorillonite sample. FIG. 7B shows the corresponding N₂ adsorption isotherms for HKUST-1 extrudates formed from mulls containing various binder additives. As shown from the hysteresis in the FIG. 7B plots, significant mesoporosity appeared to develop in the VERSAL 300 sample. Although the overall BET surface area of each extrudate decreased when the binder additive was present, discounting the surface area contribution from the binder additive showed >90% surface area retention for the HKUST-1 in the presence of both types of binder additives.

The inclusion of graphite in the solid mixture used for mulling also resulted in retention of a significant fraction of the HKUST-1 surface area while decreasing the overall extrusion pressure. At 2% graphite loading (wt. % of the total solids present in the solid mixture used for mulling; 43% total solids content of mull), the total BET surface area of the extrudate was 1701 m²/g, whereas at 20% graphite loading, the total BET surface area dropped to 1327 m²/g. Upon correction for the surface area contribution of graphite the extrudate containing 20% graphite, the HKUST-1 surface area remained around 94% that of the HKUST-1 powder material. Notably, including 20% graphite in the mull significantly lowered the pressure needed to affect extrusion.

Table 1 below summarizes the BET surface areas, crystallinity, and crush strength values for the HKUST-1 extrudates formed as above. Crystallinity was determined semi-quantitatively based upon comparison of the x-ray powder diffraction peak intensity at a 20 value of 12° for each extrudate against the intensity of the same peak in the HKUST-1 powder material.

TABLE 1

| | | BET | | |
|---|---|---|---|---|
| | | Surface | | Crush |
| | | Area | Crystallinity | Strength |
| Entry | Sample Type | (m²/g) | (%) | (lb/in) |
| 1 | HKUST-1 powder | 1766 | 100 | ND |
| 2 | HKUST-1 1:1 | 1679 | 100 | 75.9 |
| | H₂O:EtOH extrudate | | | |
| 3 | HKUST-1 3:1 | 1656 | 45 | 82.5 |
| | H₂O:EtOH extrudate | | | |
| 4 | HKUST-1 9:1 | 1257 | 44 | ND |
| | H₂O:EtOH extrudate | | | |
| 5 | HKUST-1 24:1 | 997 | 30 | ND |
| | H₂O:EtOH extrudate | | | |
| 6 | HKUST-1 100% | 29 | 0 | ND |
| | H₂O extrudate | | | |
| 7 | HKUST-1 100% | 1675 | 97 | ND |
| | EtOH extrudate | | | |
| 8 | HKUST-1 1:1 | 1136 | 71 | 60.1 |
| | H₂O:EtOH extrudate | | | |
| | (65% HKUST-1/35% | | | |
| | montmorillonite) | | | |
| 9 | HKUST-1 1:1 | 1125 | 83 | 93.6 |
| | H₂O:EtOH extrudate | | | |
| | (65% HKUST-1/35% | | | |
| | VERSAL 300) | | | |
| 10 | HKUST-1 1:1 | 1355 | 100 | ND |
| | H₂O:EtOH extrudate | | | |
| | (80% HKUST-1/20% | | | |
| | VERSAL 300) | | | |

Crush strength values of about 50 lb/in are considered acceptable for many types of industrial processes.

Alcohols other than ethanol were also investigated for their ability to promote extrusion. Specifically, 1-propanol, 1-butanol and 1-hexanol were used to replace ethanol in forming a mull with HKUST-1. 1-Propanol is water-soluble and was premixed with water to form a water:alcohol mixture as was conducted with ethanol. 1-Butanol and 1-hexanol are not fully miscible with water and were added neat to the HKUST-1 sample first to affect mulling. Thereafter, a sufficient amount of water was added to provide a 1:1 mixture of water:alcohol in the mull. The solids content of the resulting mulls was 43% in each case. Table 2 below summarizes the BET surface areas and crush strength values obtained upon extruding mulls containing each alcohol. The ethanol extrudate data from above is also included for comparison.

TABLE 2

| | | BET Surface | Crush Strength |
|---|---|---|---|
| Entry | Sample Type | Area (m²/g) | (lb/in) |
| 2 | HKUST-1 1:1 | 1679 | 75.9 |
| | H₂O:EtOH extrudate | | |
| 11 | HKUST-1 1:1 | 1601 | 49.7 |
| | H₂O:1-propanol extrudate | | |
| 12 | HKUST-1 1:1 | 1450 | 56.2 |
| | H₂O:1-butanol extrudate | | |
| 13 | HKUST-1 1:1 | 717 | 28.0 |
| | H₂O:1-hexanol extrudate | | |

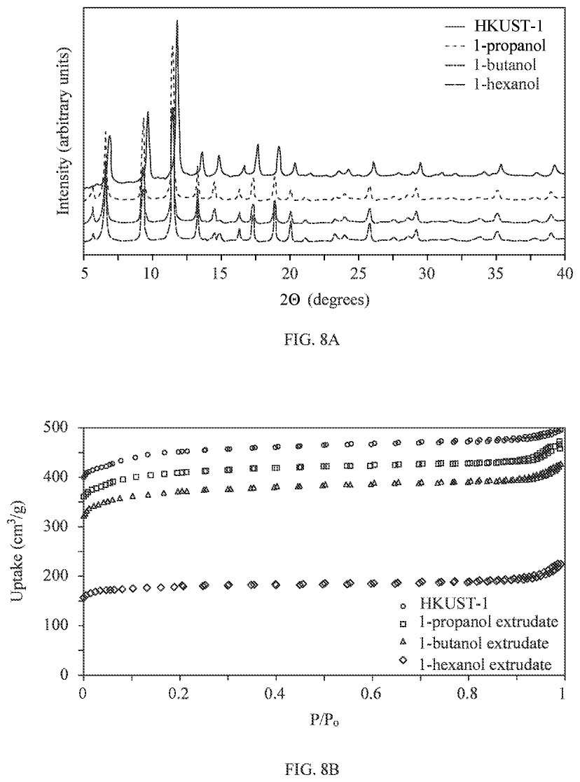

Longer chain alcohols (butanol and above) were not as effective in preserving the properties of the metal-organic framework powder material, particularly in combination with sufficient crush strength. FIG. 8A shows comparative x-ray powder diffraction data for HKUST-1 extrudates formed from mulls containing various alcohols. FIG. 8B shows the corresponding N₂ adsorption isotherms. As shown in FIG. 8A, the HKUST-1 crystalline phase appeared to be largely retained for each alcohol.

In addition, to retaining the HKUST-1 crystalline phase and maintaining high BET surface areas, the HKUST-1 extrudates also exhibited a high gas absorption capacity. FIG. 9 shows a plot of methane uptake for HKUST-1 powder in comparison to several HKUST-1 extrudates. As shown, the HKUST-1 extrudate formed from a 1:1 water:ethanol mixture afforded a slightly superior methane uptake compared to HKUST-1 powder. The HKUST-1 extrudate formed using 35% VERSAL 300 binder additive afforded a lower methane uptake, likely due to its lower BET surface area resulting from the presence of the binder additive. Even so, the decrease was only about 20% compared to HKUST-1 powder, which is less than expected based upon the amount of binder additive present in the extrudate.

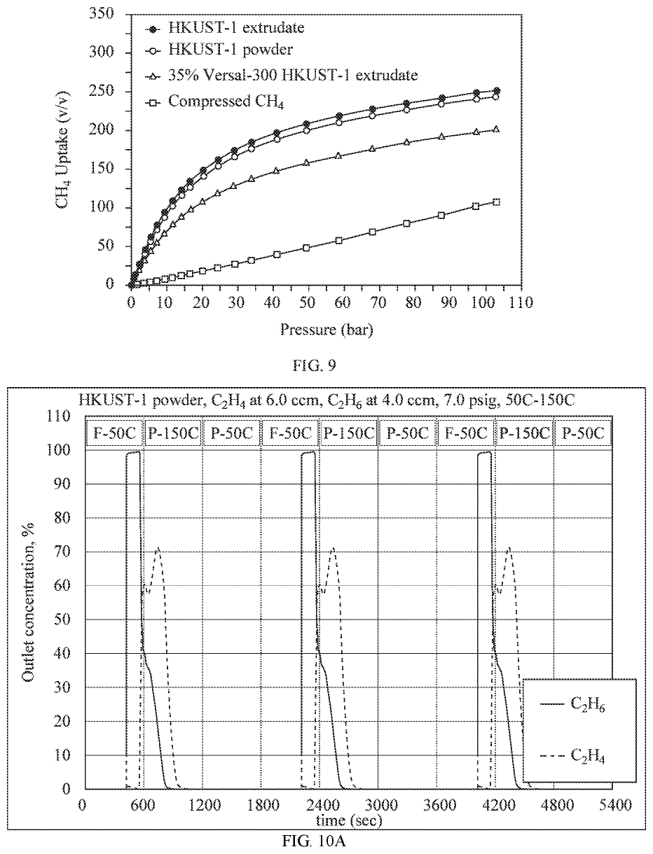

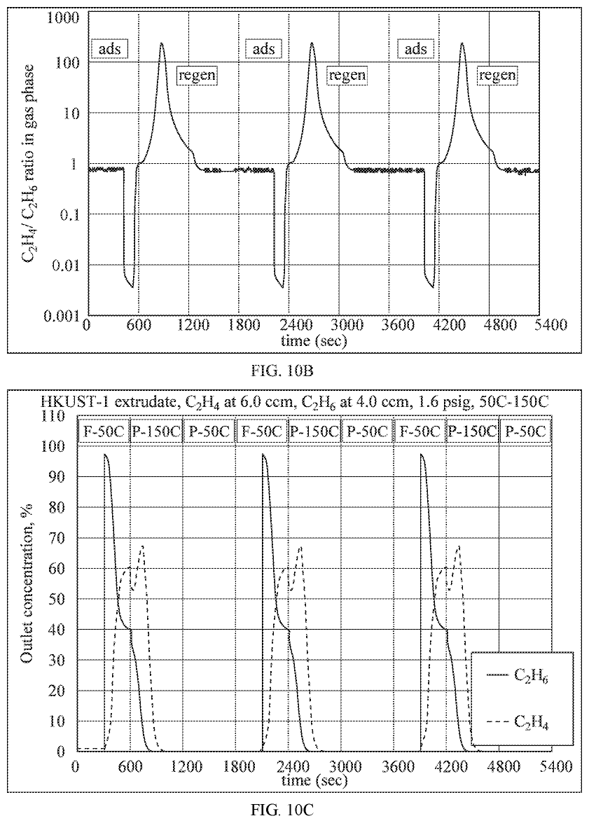

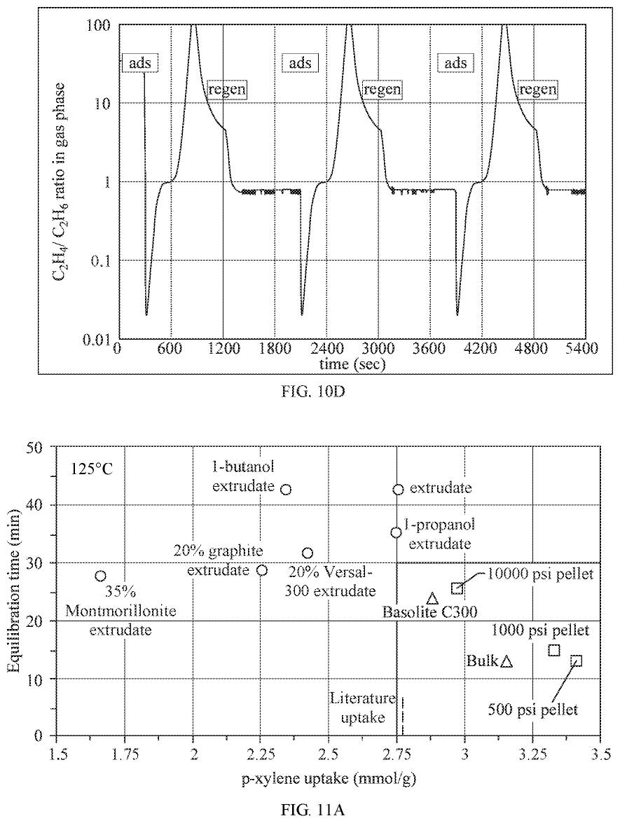

The extrudates also may be effective for separating ethane and ethylene from one another. Each sample was loaded as a packed bed and exposed to a mixture of 60:40 ethylene:ethane at 50° C. The gas composition on the bed outlet was measured by mass spectrometer to determine the gas composition and purity of both ethane and ethylene flowing from the bed. FIGS. 10A-10D show illustrative breakthrough plots for ethane/ethylene gas absorption for HKUST-1 powder (FIGS. 10A and 10B) and HKUST-1 extrudate (FIGS. 10C and 10D). As shown, both types of HKUST-1 samples exhibited similar breakthrough properties. Namely, ethane and ethylene were separated from one another, with ethane breaking through the bed first due to preferential ethylene adsorption. During bed regeneration at 150° C., trace amounts of ethane desorb first, thereafter producing either significantly enriched or pure ethylene at the outlet.

FIGS. 11A and 11B show the performance of various HKUST-1 extrudates for uptake of p-xylene and o-xylene, respectively, in comparison to that of HKUST-1 powder and HKUST-1 pressed pellets. As shown, the uptake for both xylene isomers was lower and required a longer equilibration time for most of the extrudates compared to the HKUST-1 pressed pellets or HKUST-1 powder. Nevertheless, the uptake remained at acceptable levels.

### Example 2: ZIF-7

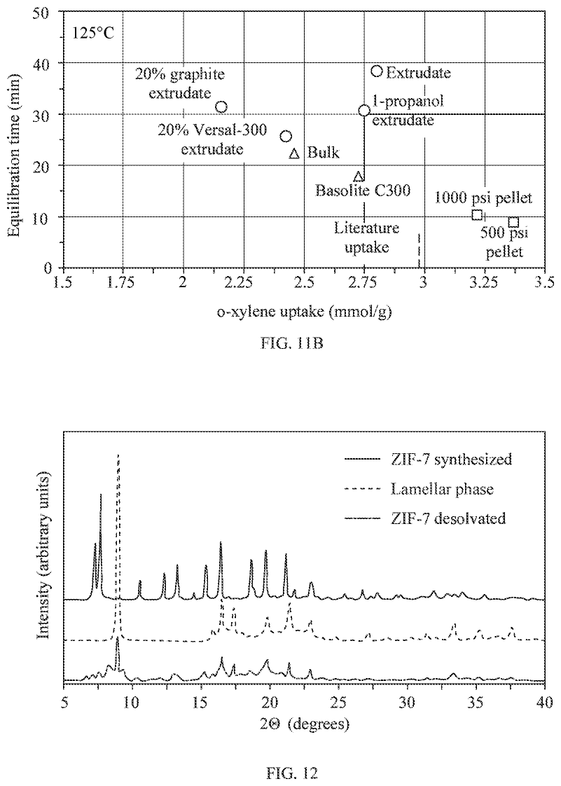

ZIF-7 was synthesized by combining 75 g of benzimidazole and 75 g of Zn(OAc)₂.2H₂O in 1.5 L ethanol. To the reaction mixture was added 75 mL 28-30% ammonium hydroxide. The combined reaction mixture was then stirred for 5 hours. The product was collected by filtration and washed with ethanol to provide a white powder. FIG. 12 shows comparative x-ray powder diffraction data for as-synthesized ZIF-7 and heat-desolvated ZIF-7. Desolvation resulted in partial formation of a lamellar phase (also apparent in FIG. 12). Surface area measurements were not conducted, since this MOF is not porous to N₂.

Pelletization Experiments.

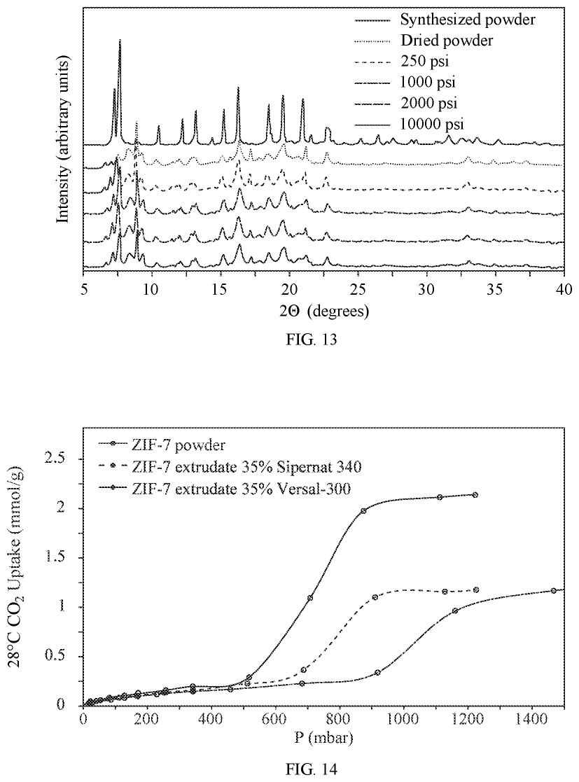

Pelletization was conducted initially as a surrogate of extrusion. Dried (heat activated) and solvated (undried, as-synthesized) samples of ZIF-7 were compacted in a hydraulic press at pressures of 250, 500, 1000 and 10000 psi for 1 minute. Dried ZIF-7 failed to form a consolidated pellet, even at 10000 psi of applied pressure. As-synthesized ZIF-7, in contrast, formed consolidated pellets, although the pellets were very brittle and produced fines when lightly touched. FIG. 13 shows comparative x-ray powder diffraction data for pellets formed from dried and as-synthesized ZIF-7 and as-synthesized ZIF-7 powder. As shown, the ZIF-7 crystalline form was maintained following compaction, although some of the lamellar phase (FIG. 12) still formed during compression, as indicated by ingrowth of the peak at a 20 value of 9.1°.

Extrusion Experiments.

Since pelletization of ZIF-7 resulted in very brittle pellets, no extrusion experiments were conducted with ZIF-7 alone. That is, a binder additive was included with the ZIF-7 in all instances when forming a mull and subsequently extruding. Specifically, a mull was formed by hand in a mortar and pestle with VERSAL 300 constituting 35% of the solids content in the mull. Ethanol was used as the wetting solvent. Mulls containing 55% and 58% solids were capable of being extruded, but the mulls exhibited immeasurably low crush strengths, even in the presence of the binder additive. Increasing the binder additive content in the mull up to 60% of the solids content (VERSAL 300 or SIPERNAT 340 silica) still did not result in a significant improvement in the crush strength. Partial formation of the lamellar phase was also noted in the extrudates (x-ray powder diffraction data not shown).

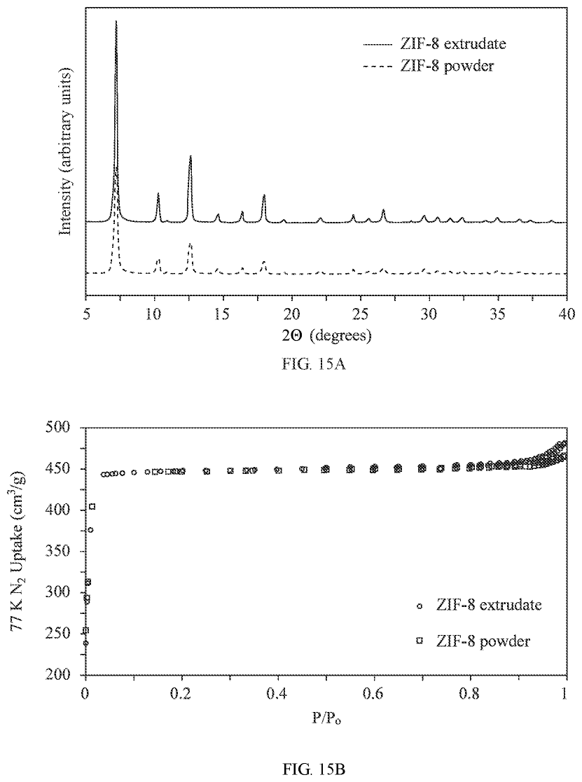

The ZIF-7 extrudates retained CO2 adsorption capabilities, in spite of the low crush strength values. FIG. 14 shows comparative CO2 adsorption isotherms at 28° C. for ZIF-7 extrudates in comparison to activated ZIF-7 powder. After normalizing for the presence of the binder additive, the CO2 adsorption capacity for the extruded ZIF-7 was approximately 85% that of the ZIF-7 powder. Notably, fines formed for the VERSAL 300 extrudate, whereas no fines were formed from the SIPERNAT 340 extrudate during CO2 adsorption measurements.

### Example 3: ZIF-8

Commercial ZIF-8 was used as received and did not demonstrate measurable solvent content when heated. Following extrusion (see below), a slight odor of DMF was noted, which may be indicative of a small amount of retained solvent in the as-received ZIF-8.

Extrusion Experiments.

ZIF-8 was mulled by hand in a mortar and pestle with 1:1 water:ethanol as the mulling solvent. The solids content was 41.7%. After mulling, the crystalline phase of the ZIF-8 was retained, as shown by the comparative x-ray powder diffraction patterns in FIG. 15A. Based on the low-angle peak intensities, the crystallinity of the extrudate appeared to exceed that of ZIF-8 powder. FIG. 15B shows the corresponding N₂ adsorption isotherms at 77 K. The calculated BET surface area of the extrudate was 1791 m²/g in comparison to 1608 m²/g for the ZIF-8 powder. Unfortunately, the crush strength of the ZIF-8 extrudate lacking a binder additive was immeasurably low.

VERSAL 300 was combined with ZIF-8 at varying amounts (up to 35%) of the total solids content in the mull. Mulling and extrusion were conducted in a similar manner to the ZIF-8 samples lacking a binder additive. Table 3 below summarizes the data for ZIF-8 extrudates including VERSAL 300 as a binder additive.

TABLE 3

| | | | | | BET | |
|---|---|---|---|---|---|---|
| | | | | Total | Surface | Crush |
| | Extrudate | Extrudate | VERSAL | Solids | Area | Strength |
| Entry | Shape | Size (in) | 300 (%) | (%) | (m²/g) | (lb/in) |
| 14 | cylinder | 1/16 | 0 | 41.7 | 1791 | ND |
| 15 | cylinder | 1/16 | 35 | 50.4 | 1206 | 13.9 |
| 16 | cylinder | 1/32 | 20 | 48.3 | 1351 | low |
| 17 | cylinder | 1/32 | 20 | 52 | 1361 | low |
| 18 | square | 1/16 | 0 | 47.5 | 1501 | low |
| 19 | square | 1/16 | 35 | 50 | 1232 | 24.1 |

Although the target crush strength value of 50 lb-ft/in was not achieved with VERSAL 300 in this limited set of samples, some improvement in the crush strength did occur in this case. After normalizing for the presence of the binder additive, essentially 100% of the ZIF-8 surface area was retained in the extrudates.

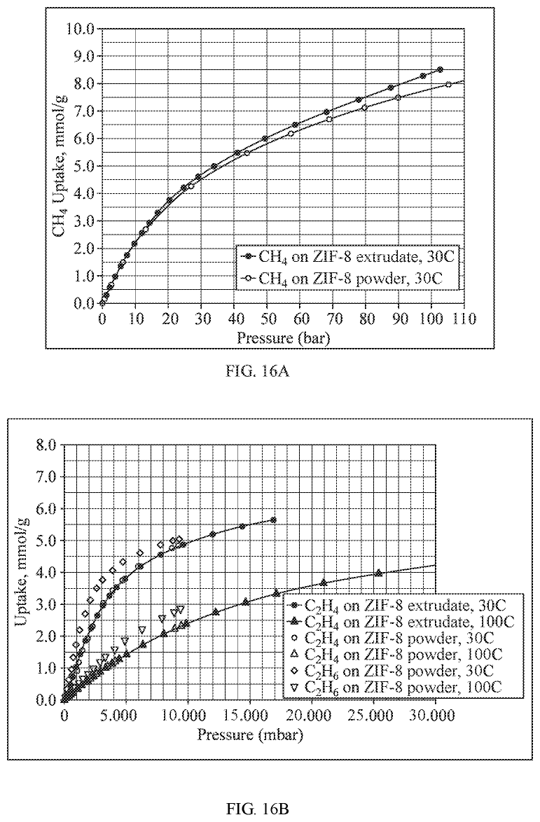

Methane and ethylene adsorption isotherms were obtained for the ZIF-8 extrudate from Entry 18. Despite the low crush strength of this sample, no fines were observed following gas exposure. The methane adsorption isotherms were obtained at 30° C., and the ethylene adsorption isotherms were obtained at 30° C. and 100° C. FIG. 16A shows methane adsorption isotherms for ZIF-8 extrudate in comparison to ZIF-8 powder, and FIG. 16B shows ethylene adsorption isotherms for ZIF-8 extrudate in comparison ZIF-8 powder. As shown, the properties of the MOF powder were largely retained in the extrudates.

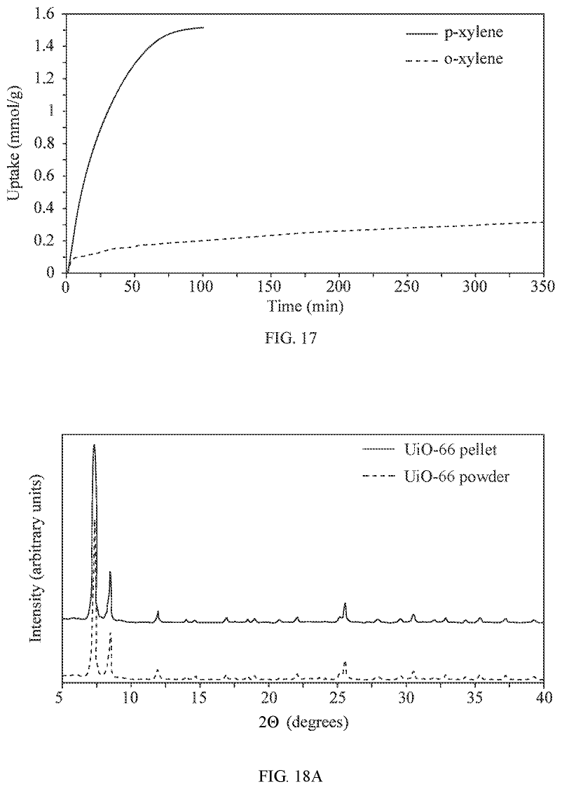

As shown in FIG. 17, the ZIF-8 extrudate demonstrated selectivity for adsorption of p-xylene over o-xylene.

### Example 4: UiO-66

Commercial UiO-66 was used as received and did not demonstrate measurable solvent content when heated.

Pelletization Experiments.

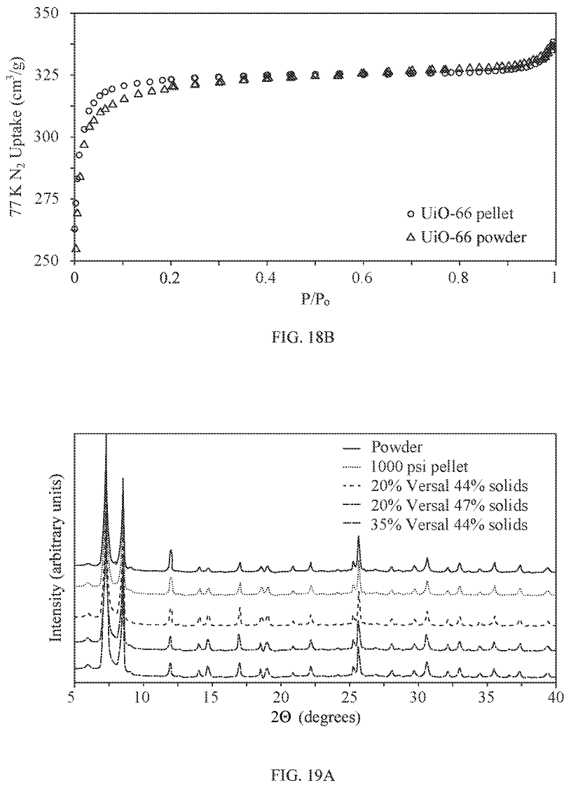

A self-bound pellet of UiO-66 was prepared as in Example 1 by compression at 1000 psi for 1 minute. FIG. 18A shows the x-ray powder diffraction patterns of the UiO-66 pellet in comparison to UiO-66 powder. As shown, no significant changes occurred upon pelletizing UiO-66. The BET surface area of the pellet was 1295 m²/g in comparison to 1270 m²/g for the powder. FIG. 18B shows the corresponding N₂ adsorption isotherms.

Extrusion Experiments.

UiO-66 was mulled by hand in a mortar and pestle with 1:1 water:ethanol as the mulling solvent. At a solids content of 41.9%, a coherent extrudate was not produced at extrusion pressures of 2500-9000 psi. Only wet slurry was obtained from the extruder. UiO-66 is stable in water, so extrusion in 100% water was attempted next at a solids content of 38.7%. Again, a coherent extrudate was not obtained.

Next, various quantities of VERSAL binder additive were included when forming a mull from UiO=66. Table 4 below summarizes the properties of the resulting UiO-66 extrudates. 1:1 Water:ethanol was used as the mulling solvent

TABLE 4

| | | Binder | | BET | |
|---|---|---|---|---|---|
| | | Additive | Total | Surface | Crush |
| | Binder | Loading | Solids | Area | Strength |
| Entry | Additive | (%) | (%) | (m²/g) | (lb/in) |
| 20 | VERSAL 300 | 20 | 44 | 1000 | low |
| 21 | VERSAL 300 | 20 | 47 | 1013 | low |
| 22 | VERSAL 300 | 35 | 44 | 895 | low |
| 23 | PVA | 22-23 | 44 | 913 | ND |
| 24 | PVA | 22-23 | 47 | 894 | ND |

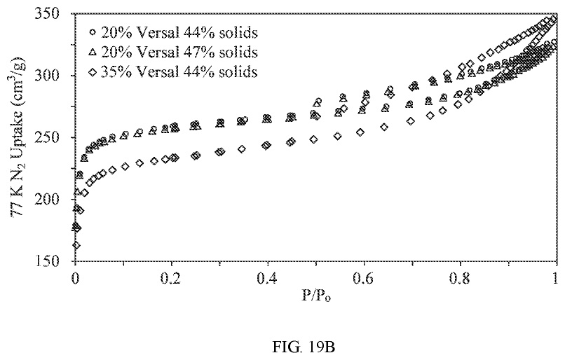

FIG. 19A shows comparative x-ray powder diffraction data for UiO-66 extrudates containing VERSAL 300 as a binder additive. As shown in FIG. 19A, the UiO-66 phase was retained in the extrudates. FIG. 19B shows the corresponding N₂ adsorption isotherms at 77 K. After accounting for the presence of the binder additive, greater than 92% of the UiO-66 surface area was retained in the extrudates. The N₂ adsorption isotherms, indicated slight development of mesoporosity in the extrudates, especially with 35% VERSAL 300. Crush strengths for the UiO-66 extrudates containing VERSAL 300 remained too low to be measured, however.

Polyvinyl alcohol (PVA) was used as an alternative binder additive, with deionized water being used as the solvent during mulling. As shown in Table 4 above, the BET surface area remained high for these extrudates and >90% of the UiO-66 surface area was retained after taking the binder additive into account. Surprisingly, the addition of PVA to the mull resulted in a lower extrusion pressure.

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the disclosure have been illustrated and described, various modifications can be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

One or more illustrative embodiments are presented herein. Not all features of a physical implementation are described or shown in this application for the sake of clarity. It is understood that in the development of a physical embodiment of the present disclosure, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for one of ordinary skill in the art and having benefit of this disclosure.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to one having ordinary skill in the art and having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein.

1. An extrudate comprising:
a metal-organic framework consolidated material formed via extrusion of a mull comprising a pre-crystallized metal-organic framework powder material;
wherein the metal-organic framework consolidated material has a BET surface area of about 50% or greater relative to that of the pre-crystallized metal-organic framework powder material, and x-ray powder diffraction of the extrudate shows about 20% or less conversion of the pre-crystallized metal-organic framework powder material into a different phase within the metal-organic framework consolidated material following extrusion, as measured by peak intensity of one or more x-ray powder diffraction peaks.

2. The extrudate of claim 1, wherein the metal-organic framework consolidated material has a BET surface area of about 80% or greater relative to that of the pre-crystallized metal-organic framework powder material.

3. The extrudate of claim 1, wherein the metal-organic framework consolidated material has a BET surface area of about 90% or greater relative to that of the pre-crystallized metal-organic framework powder material.

4. The extrudate of claim 1, further comprising:
a binder additive that is present in the mull and is co-extruded when forming the metal-organic framework consolidated material.

5. The extrudate of claim 4, wherein the binder additive is selected from the group consisting of a clay, a polymer, an oxide powder, and any combination thereof.

6. The extrudate of claim 4, wherein the binder additive is selected from the group consisting of montmorillonite, kaolin, alumina, silica, any combination thereof.

7. The extrudate of claim 1, wherein the pre-crystallized metal-organic framework powder material is selected from the group consisting of a trimesate, a terephthalate, an imidazolate, and any combination thereof.

8. The extrudate of claim 1, wherein the pre-crystallized metal-organic framework powder material is selected from the group consisting of HKUST-1, ZIF-7, ZIF-8, and UiO-66.

9. The extrudate of claim 1, wherein the BET surface area of the metal-organic framework consolidated material is greater than the BET surface area of the pre-crystallized metal-organic framework powder material.

10. The extrudate of claim 1, wherein the extrudate has a crush strength of about 30 lb/in or greater.

11. The extrudate of claim 1, wherein the extrudate consists essentially of the metal-organic framework consolidated material.

12. A method comprising:
combining a pre-crystallized metal-organic framework powder material with a solvent, the solvent comprising one or more solvents used to form the pre-crystallized metal-organic framework powder material;
mixing the pre-crystallized metal-organic framework powder material with the solvent to form a mulled metal-organic framework paste;
wherein mixing is conducted such that about 20% or less of the pre-crystallized metal-organic framework powder material is transformed into a different phase, as determined by x-ray powder diffraction; and
extruding the mulled metal-organic framework paste to form an extrudate comprising a metal-organic framework consolidated material;
wherein the metal-organic framework consolidated material has a BET surface area of about 50% or greater relative to that of the pre-crystallized metal-organic framework powder material, and x-ray powder diffraction of the extrudate shows about 20% or less conversion of the pre-crystallized metal-organic framework powder material into a different phase within the metal-organic framework consolidated material following extrusion, as measured by peak intensity of one or more x-ray powder diffraction peaks.

13. The method of claim 12, wherein the metal-organic framework consolidated material has a BET surface area of about 80% or greater relative to that of the pre-crystallized metal-organic framework powder material.

14. The method of claim 12, wherein the metal-organic framework consolidated material has a BET surface area of about 90% or greater relative to that of the pre-crystallized metal-organic framework powder material.

15. The method of claim 12, wherein mixing comprises mulling the pre-crystallized metal-organic framework powder material with the solvent.

16. The method of claim 12, wherein the pre-crystallized metal-organic framework powder material is selected from the group consisting of a trimesate, a terephthalate, an imidazolate, and any combination thereof.

17. The method of claim 12, wherein the pre-crystallized metal-organic framework powder material is selected from the group consisting of HKUST-1, ZIF-7, ZIF-8, and UiO-66.

18. The method of claim 1, wherein the solvent comprises an alcohol.

19. The method of claim 18, wherein the solvent comprises an alcohol/water mixture.

20. The method of claim 18, wherein the alcohol comprises ethanol.

21. The method of claim 18, wherein the pre-crystallized metal-organic framework powder material comprises HKUST-1.

22. The method of claim 12, wherein the solvent comprises an aqueous solvent.

23. The method of claim 22, wherein the aqueous solvent comprises a mixture of water and a water-miscible alcohol.

24. The method of claim 12, further comprising:
heating the extrudate after extrusion.

25. The method of claim 12, wherein the mulled metal-organic framework paste consists essentially of the pre-crystallized metal-organic framework powder material and the solvent.

26. The method of claim 12, wherein the mulled metal-organic framework paste consists essentially of the pre-crystallized metal-organic framework powder material, a binder additive, and the solvent;
wherein the binder additive is retained in the extrudate.

27. A method comprising:
combining a pre-crystallized metal-organic framework powder material with a solvent selected from the group consisting of an alcohol and an alcohol/water mixture;
mixing the pre-crystallized metal-organic framework powder material with the solvent to form a mulled metal-organic framework paste;
wherein mixing is conducted such that about 20% or less of the pre-crystallized metal-organic framework powder material is transformed into a different phase, as determined by x-ray powder diffraction; and
extruding the mulled metal-organic framework paste to form an extrudate comprising a metal-organic framework consolidated material;
wherein the metal-organic framework consolidated material has a BET surface area of about 50% or greater relative to that of the pre-crystallized metal-organic framework powder material, and x-ray powder diffraction of the extrudate shows about 20% or less conversion of the pre-crystallized metal-organic framework powder material into a different phase within the metal-organic framework consolidated material following extrusion, as measured by peak intensity of one or more x-ray powder diffraction peaks.

28. The method of claim 27, wherein the metal-organic framework consolidated material has a BET surface area of about 80% or greater relative to that of the pre-crystallized metal-organic framework powder material.

29. The method of claim 27, wherein the metal-organic framework consolidated material has a BET surface area of about 90% or greater relative to that of the pre-crystallized metal-organic framework powder material.

30. The method of claim 27, wherein mixing comprises mulling the pre-crystallized metal-organic framework powder material with the solvent.

31. The method of claim 27, wherein the BET surface area of the metal-organic framework consolidated material is greater than the BET surface area of the pre-crystallized metal-organic framework powder material.

32. The method of claim 27, wherein the extrudate has a crush strength of about 30 lb/in or greater.

33. The method of claim 27, further comprising:
heating the extrudate after extrusion.

34. The method of claim 27, wherein the mulled metal-organic framework paste consists essentially of the pre-crystallized metal-organic framework powder material and the solvent.

35. The method of claim 27, wherein the mulled metal-organic framework paste consists essentially of the pre-crystallized metal-organic framework powder material, a binder additive, and the solvent;
wherein the binder additive is retained in the extrudate.

36. The method of claim 27, wherein the pre-crystallized metal-organic framework powder material comprises HKUST-1.
